(19) United States
(12) Patent Application Publication
(10) Pub. No.: US 2021/0261454 A1
(43) Pub. Date: Aug. 26, 2021

(54) METHOD AND ARRANGEMENT FOR SEPARATING SOLIDS AND LIQUIDS IN SUSPENSIONS, IN PARTICULAR SEWAGE SLUDGE, BY ADDING FLOCCULANTS

(71) Applicant: AWAMA GMBH, Braunschweig (DE)

(72) Inventor: Jochen Gassmann, Salzgitter (DE)

(73) Assignee: awama GmbH, Braunschweig (DE)

(21) Appl. No.: 17/253,734

(22) PCT Filed: Jul. 4, 2019
(86) PCT No.: PCT/EP2019/067990

§ 371 Date: Dec. 18, 2020

(30) Foreign Application Priority Data
Jul. 4, 2018 (DE) 10 2018 116 196.4

(51) Int. Cl. C02F 11/147; G01N 15/14

(52) U.S. Cl. CPC C02F 11/147; G01N 2015/1486; C02F 2209/105; G01N 15/1463

(57) ABSTRACT

The invention relates to a method for separating solids and liquids in suspensions, in particular sewage sludge (K), said method working by adding flocculants (F1) and/or flocculating agents. The suspension, in particular the sewage sludge (K), is observed by means of a sensor (S1). In a first method step, flocculants (F1) and/or flocculating agents are added to a first mixing stage (M1) until the sensor (S1) detects the formation of first flocs. The addition of the flocculant (F1) and/or the flocculating agent is then interrupted so that the suspension, in particular the sewage sludge (K), has a defined, specifically a first, floc-comprising state at that moment. The suspension, in particular the sewage sludge (K), is now fed to a further mixing stage (M2, MM). In this further mixing stage (M2, MM), the same (F1) or another (F2, F3) flocculant or flocculating agent is added in a quantity which is predefined and which, starting from the defined state of the suspension, in particular the sewage sludge (K), causes a desired amount of flocs in the suspension, in particular the sewage sludge (K). The resulting mixture is then fed directly or indirectly to a solid/liquid separation system.

The invention relates to a method for separating solids and liquids in suspensions, in particular sewage sludge, by adding flocculants and/or flocculating agents, in which the suspension, in particular the sewage sludge, is observed by means of a sensor.

The invention further relates to an arrangement for separating solids and liquids in suspensions, in particular sewage sludge, by adding flocculants and/or flocculating agents, in which the suspension, in particular the sewage sludge, is observed by means of a sensor.

Both in the municipal sector and in the industrial sector, there are a large number of wastewater treatment plants in use. The operation of wastewater treatment plants of this kind creates sewage sludge in large amounts. Sewage sludge is composed of organic and inorganic constituents, which can be solids and dissolved constituents in very diverse ratios to one another. The sewage sludge is formed from substances contained in the wastewater and also as a result of additional reactions in an excess biomass in the wastewater treatment plants. The sewage sludge is generally present as a suspension containing particles and colloids.

After it has formed in the wastewater treatment plants, the sewage sludge must be disposed of in suitable form. Coming into consideration for this is an agricultural or thermal utilization as well as also in part—depending on the region or country—deposition in a landfill.

It is appropriate to reduce beforehand the volume of the sewage sludge. For this purpose, a separation of solids and liquids in the sewage sludge is carried out. In many cases, this means a dewatering, that is, a separation of the water portion. Purely in principle, liquids other than water can also be separated in order to reduce the volume, but, in practice, the water portion is the most important.

This separation of solids and liquids or, in particular, dewatering occurs in order to be able to treat further the greatest possible amount of the contained water, separated from the solid constituents, in one of the aforementioned ways or in another way and, in particular, to be able thereby to recover or dispose of this greatest possible amount of water.

Coming into consideration for such a separation of solids and liquids or dewatering are a filtration or a centrifugation and other mechanical dewatering methods. These mechanical methods are definitely considerably more effective and cost-efficient than a treatment of the remaining constituents of the sewage sludge carried out in another way.

Therefore, the aim is to achieve by all means an optimization of these mechanical dewatering methods in order to obtain overall a more cost-efficient and also environmentally friendly disposal of the sewage sludge from the wastewater treatment plants.

A treatment of sewage sludge by using thermal methods, such as, for example, a drying or a combustion, is cost-intensive and should therefore be carried out insofar as possible only with portions of the sewage sludge that necessarily need to be processed in this way.

There already exist a number of proposals as to how to process sewage sludge so that its dewaterability is increased.

A successful proposal to this end has been published in EP 1 373 145 B1. The addition of flocculants and flocculating agents investigated there influences the dewatering characteristics of the sewage sludge in a positive manner. The sewage sludge is “conditioned” in this way and the floc formation can be accomplished in a very targeted manner.

However, the flocculants do not change anything in the fact that the characteristics of the sewage sludge are subject to very great fluctuations not only from plant to plant, but also in terms of the time of year and the time of day, because they depend on a large number of influencing variables. The sewage sludge in wastewater treatment plants is also influenced, of course, by the characteristics of the wastewater that is supplied and is to be cleaned, which dictates the amount of organic dry substance. The material characteristics also influence the charge potential, the surface properties, the amount of fine particles, and other influencing variables.

In EP 1 373 145 B1, it is proposed to create a view from the top of the sewage sludge transversely with respect to the flow direction of the flowing sewage sludge by means of photo-optical incident light measurements and to investigate the floc structure more closely by using the grayscale profiles obtained from this top view of the sewage sludge. By way of a mathematical procedure, described in greater detail, starting points relating to a concentration factor are obtained.

This concentration factor can be used for determining a target concentration for the dewatered sewage sludge and it then becomes possible to carry out a need-based addition of flocculant online in a practical manner. It should thereby be possible to control the quantity of added flocculant as optimally as possible in order to optimize in turn the dewaterability of the sewage sludge that is to be treated as much as possible through an optimal choice of flocculant.

These concepts that have been developed are certainly very promising. However, they presuppose that the flocs of the sewage sludge that are formed correspond to structures that are assumed to be present. If the flocs do not have this assumed structure, then the quantity of required and added flocculant thereby determined also will be determined incorrectly.

The application of the method described in EP 1 373 145 B1 tends to lead to an addition of flocculants in amounts that are too great. However, corrections are difficult to make.

Known from DE 696 04 348 T2, which corresponds to EP 0 754 941 B1, is another device for detecting the characteristics of sludge-like materials as well as a sludge treatment method. Used in this case, for the treatment of industrial wastewaters and wastewater sludges, is a method that operates with two flocculants, which are added in two different stages to the sludge that is to be treated. The method operates as a two-stage process in which, in the first stage, a cationic flocculant is added and, in the second stage, an anionic flocculant is added. The two-stage flocculation thus occurs using oppositely charged flocculants and is based on the attraction of oppositely charged macromolecules or polymers.

Such a method is referred to as dual flocculation and has been employed in practice for many years in certain technical plants.

For the two flocculation stages, it is possible in each case to determine a degree of flocculation and a floc solidity by measuring the viscosity. To this end, a measuring instrument that determines the change in viscosity of the measured sludge is used. A measuring instrument of this kind cannot undertake more detailed measurements or investigations.

It is possible from the described viscosity measurement, however, to carry out a control of the quantities of the added polymers in the two stages to a certain degree during a dual flocculation, at least in order to aim for an improvement in the results for the dewatering operation as well.

The degree of flocculation and the floc solidity are determined in DE 696 04 348 T2 as well as in EP 0 754 941 B1 beyond a certain particle level. This determination is made after the flocculation and the flocculation process, which can then be appropriately evaluated. The values found according to the determination can then be used for controlling the added quantities.

For the very special design of dual flocculation, that is, the two-stage flocculation using macromolecules or polymers that are opposite in charge to each other, a determination of the degree of flocculation after the flocculation process is definitely appropriate and may even contribute to the success of a dual flocculation, because flocculation is carried out in both stages of the flocculation process. Owing to the polymers that are opposite in charge to each other, the flocs formed in the first stage are further formed in a second stage to create larger flocs. For this, of course, investigations need to take place at a later point in time of the flocculation.

Another proposal for improving the dewaterability of sewage sludge from wastewater treatment plants and also of other suspensions is published in EP 1 432 502 B1. Here, too, a flocculation apparatus is operated and a flocculant and/or a flocculating agent is dispersed in a suspension by using a mixer to produce turbulent flow motions. In this way, flocs are formed in and from the suspension. The pelletizing and rounding of the flocs in the flocculation apparatus by shear forces and floc erosion have also already been investigated. The ability to dewater the sewage sludge can be further improved in this way. It is to be noted that the shear forces cannot become so great that the flocs are destroyed once again and that the thereby desired characteristics diminish once again.

Therefore, there exists the desire to further improve the optimization of the dewatering behavior of sewage sludges. Flocculants and flocculating agents are also to be used here, but a procedural approach is to be chosen that leads to results that are even more favorable and, by way of dewatering, also optimize a reduction in the volume of the sewage sludge.

The object of the invention is therefore to further improve a generic method and a generic arrangement in this form.

This object is achieved in accordance with the invention for a generic method in that, in a first method step, flocculants and/or flocculating agents are added to a first mixing stage until the formation of the first flocs is detected by means of a sensor; the addition of the flocculant and/or the flocculating agent is then interrupted, so that the suspension, in particular the sewage sludge, has a defined state, specifically a first, floc-comprising state at that moment; that the suspension, in particular the sewage sludge, is now fed to a further mixing stage; in this further mixing stage, the same or another flocculant or flocculating agent is added in a quantity which is predefined and which, starting from the defined state of the suspension, in particular the sewage sludge. causes a desired proportion of flocs in the suspension, in particular the sewage sludge; and that the resulting mixture is then fed directly or indirectly to a dewatering system.

In a generic arrangement, the object is achieved by means of the invention in that a first mixing stage is provided, in which, in a first method step, the addition of flocculants and/or flocculating agents occurs until the formation of the first flocs is detected by means of a sensor; in that the addition of the flocculant and/or the flocculating agent is then interrupted, so that the suspension, in particular the sewage sludge, has a defined state, specifically a first, floc-comprising state at that moment; in that a further mixing stage is provided, to which the suspension, in particular the sewage sludge, is fed; in that, in this further mixing stage, the same or another flocculant or flocculating agent is added in a quantity that is predefined and, starting from a defined state of the suspension, in particular the sewage sludge, causes a desired proportion of flocs in the suspension, in particular the sewage sludge; and in that the resulting mixture is then fed directly or indirectly to a dewatering system.

First and foremost, the invention is an improvement for methods that aim at a dewatering of sewage sludge. However, it is also possible to apply the invention to other methods that operate with the addition of flocculants and/or flocculating agents and involve flocculation processes for suspension flocculation. Besides sewage sludge, it can be carried out also for processing sediment sludge, other kinds of sludge, or even totally different operations in which solid-liquid separation operations are to be conducted using the addition of flocculants and/or flocculating agents.

Tests have already shown that, through the use of the invention with a two-stage addition and mixing of flocculants and/or flocculating agents in suspensions, the method is substantially more effective than in the case of only a one-stage addition.

The advantages of the invention not only consist in the fact that expenses for procuring flocculants and/or flocculating agents are reduced, but also in the fact that excess added flocculants and/or flocculating agents do not need to be recovered in another form from the process or, on their part, do not increase the total amount of wastewater containing constituents that is to be processed. Through the optimal determination and addition of the quantities of flocculants and/or flocculating agents, the solid-liquid separation operation also is itself optimized with the corresponding positive consequences.

The invention makes advantageous use of the closer observation of the process of the floc formation itself. Namely, if the start of addition of a flocculant and/or flocculating agent to the sewage sludge by a mixer is observed, then, initially over a certain period of time, no flocs are yet formed, because the small amount of flocculant added up to then does not allow the effect of the attraction properties of the various polymers to become sufficiently large.

At a certain point in time, which depends on the characteristics of the sewage sludge, there is then the onset of a relatively spontaneous floc formation. This floc formation is conventionally not constant and continuous, but rather it proceeds upward and downward in a multiply zigzag manner in the known processes. The reason for this lies in the fact that, when the flocculant and/or flocculating agent is mixed into the sewage sludge, the tendency for formation of flocs initially constantly increases, but, at the same time, starting with the formation of the first flocs, the effect is manifested that the mixer utilized for mixing in the flocculant and/or flocculating agent reduces in size or destroys once again the flocs that have just formed.

During this time, however, there is a tendency for the floc formation to increase, although ineffectively and not in proportion to the quantity of flocculant and/or flocculating agent used.

At the very start, however, no flocs can yet be destroyed, because none have yet formed, but the number and size of the flocs further increases with further addition of the flocculant and/or flocculating agent. However, beyond a certain point in time, at which a sufficient quantity of flocs has formed, more flocs are destroyed owing to the action of the mixer than can be formed anew. This leads to the fact that, beyond a certain quantity of flocs, the mixer no longer has a positive effect and also to the fact that, beyond this point in time, the size of the flocs decreases once again.

A maximum value at which the number of flocs and the floc size are roughly constant is thus obtained, after which the value decreases once again.

The invention now makes use of a more precise observation of this effect in order to arrive, in overall concept, at a surprising process control that acts in an outstanding manner.

Namely, in contrast to what has hitherto been the case, the inventive concept divides the method into two basically separate steps. The first method step initially operates, as conventionally is the case, with the addition of a flocculant and/or flocculating agent to the sewage sludge and the observation of the reaction. The added quantity of flocculant and/or flocculating agent is intentionally kept relatively small, however. The sewage sludge with the added flocculant and/or flocculating agent and with the mixer utilized in the process is observed using a camera. The observation differs from that of the prior art in accordance with EP 1 373 145 B1, however, in that it is not the size or the shape of the flocs or a frequency distribution that is observed, but, instead of this, the moment at which the first flocs form is observed.

For this, a totally different form of a sensor can be employed, because only exactly this moment is to be detected precisely and no other quantitative values are relevant. An image analysis measurement of this sensor is preferred here. At the moment at which the first flocs are observed, the further feed of the flocculant and/or flocculating agent is stopped at this point or, in the case of continuously proceeding processes, the feed of flocculant and/or flocculating agent is not increased further.

The moment at which this is the case can be fed back in a control loop once again to the start of the process, so that a feed of flocculants and/or flocculating agents that is designed and optimized in accord with the expected mode of behavior can take place from the outset.

In this way, it is avoided that, owing to a feed of flocculants and/or flocculating agents that is perhaps already too strong and too intensive at the start, an overshooting of the state of the first forming flocs is caused to occur. At the same time, the quantity of flocculants or flocculating agents used in this method step can be markedly reduced.

It is also possible to use the term “minimum flocculant requirement” to describe the quantity of flocculant and/or flocculating agent that is used or, expressed differently, the quantity needed for the start of a flocculation in the suspension or in the sewage sludge. Accordingly, by using the measures taken and by observing the start of the flocculation, the beginning of interactions between the particles in the suspension or in the sewage sludge is recorded. This start of interactions between the particles occurs already at dosing quantities of the added flocculant or flocculating agent that lie below the charge neutral point of the liquid phase.

The point in time is a moment that can be readily physically detected and described and is a moment at which the suspension or the sewage sludge is present in an exactly defined state.

The quantity of the flocculant and flocculating agent that has been added up to this point in time thus lies already markedly below the quantity that can be determined by any other method.

The suspension or the sewage sludge with the already fed flocculants and/or flocculating agents, in which no flocs or only a few flocs are present, now flows further to a second section of the assembly and to a second method step. Provided here is a second mixer, leading to a further quantity of flocculants and/or flocculating agents.

In a first alternative of the method according to the invention, this quantity is constant and takes into account the circumstance that the quantity of sewage sludge that is fed to this second method step with the flocculant already added to it and thus contained in it has a very defined state. Added in this second method step, therefore, is exactly the quantity of flocculants that leads from the state of the just formed first flocs to an intended state of a specific maximum proportion of flocs in the sewage sludge and the added substances.

For this method step as well, therefore, relatively small quantities of flocculants and/or flocculating agents are required, which, moreover, are optimally appropriate in regard to the applied case.

It is no longer necessary, as in the case of conventional methods, to constantly take measures against the destruction of flocs that have formed, because only exactly predictable reactions and developments can proceed.

It is also possible to determine the dosing of the quantity of flocculants and/or flocculating agents added in the second method step, based on the quantity that has been found to be appropriate during the procedural approach in the first method step.

This course of approach is advantageous, for example, when, in the second method step, a centrifuge decanter itself is utilized. In this case, the mixing energy based on the rotational acceleration of the sludge can be exploited.

In a third alternative of the method according to the invention, no predetermined and/or constant quantity of flocculants and/or flocculating agents is added, but rather, in this case, a further optimization by way of another method is included. Coming into consideration for this second section is, for example, a procedural approach that is similar to the method proposed in EP 1 373 145 B1, that is, a procedural approach that qualitatively observes more closely the flocs actually formed in the second method step in order to undertake here a yet further optimization.

It is also possible without anything further to investigate specific particle size classes of the resulting flocs in another form and to select them as a criterion for the exact dosing of the addition of flocculants and/or flocculating agents.

The division of the procedure into two method sections and two separately proceeding mixing operations also makes it possible, of course, to use two different mixers in this case, each of which is precisely adapted to the method step in which it is to operate.

The invention with its two-stage procedural approach involving two-stage dosing and two-stage mixing, in comparison to the conventional one-stage procedural approach, leads to an especially advantageous improvement in the separation properties of the flocked particles during sedimentation, filtration, and centrifugation. The consumed quantity of flocculants and/or flocculating agents also drops dramatically, In detail, there also ensue, for example, increased rates of sedimentation with improved degrees of thickening and a greater amount of dry matter in the thickened sludge, with a higher rate of filtration with greater amounts of dry matter in the dewatered or thickened sludge portions, and with a higher shear strength of the formed flocs and a greater solids content (determined by means of the dry matter) in the dewatered or thickened sludge in the centrifugation.

Especially advantageous is also the targeted control of the quantity of added polymer, that is, of added flocculants and/or flocculating agents, in the first method step using the first dosing stage and first mixing stage. This targeted control leads to a dosed quantity that may be referred to as the minimum dosed quantity and that also characterizes the start of the flocculation, which is used for its determination.

Surprisingly, it has been found in tests that, when there is a shortfall in this minimum dosed quantity or when it is exceeded, this leads to poorer separation properties of the flocs in comparison to a pinpoint dosing. This also holds true even when the shortfall or excess amount is relatively minor.

Moreover, in a further embodiment, it is provided to insert yet another intermediate method step between the first method step and the second method step. In this intermediate method step also, a mixing stage is operated and flocculant and/or flocculating agent is fed in.

In this interposed method step, it could be possible to operate with another flocculent in order to bring about certain effects. In this way, the procedural approach adapted to the flocs just formed in the first method step can proceed further in that, with use of the other flocculant, physical or chemical reactions begin to occur with the first flocculant and with the sewage sludge and bring about modes of behavior of the suspension that seem to be appropriate for the dewatering. In another connection, a procedural approach of this kind involving two different flocculants is also referred to as a dual flocculation.

The result of this interposed intermediate method step can also be observed, in turn, by a further sensor that operates, in particular, by image analysis and/or by a camera in order to control the addition of the second flocculant and then, in what is referred to as the “second” method step—but, relative to time, is the third method step using the second mixture, to allow the original second method half to proceed.

It is especially advantageous when, as the second flocculant, a macromolecule or polymer that is identical in charge to the first flocculant is used.

The choice of a second flocculant that is identical in charge to the first flocculant has the advantage that an especially precise treatment of the sewage sludge and an especially precise determination of the point in time of the start of the flocculation is possible, with the thereby ensuing advantages in the further conduct of the method.

The method according to the invention is especially advantageous for a process control when there are operational fluctuations in the characteristics of the sewage sludge that is to be treated. In accordance with the invention, it is possible to conduct an automated adjustment of the quantity of flocculant and/or flocculating agent to the start of the actual onset of the flocculation in the sewage sludge.

The above-mentioned two-stage method should not be confused with the so-called dual flocculation or two-stage flocculation, as has also been described above in connection with DE 696 04 348 T2 or EP 0 754 941 B1, for example. This dual flocculation presupposes, as cationic and anionic flocculants, macromolecules or polymers that are necessarily opposite in charge to each other and are added to the sewage sludge in two different flocculation stages.

In the invention, although such a dual flocculation can be improved as well, it is also possible, in particular, to conduct a twofold flocculation using the same flocculant or else to conduct a twofold addition of identically charged macromolecules or polymers. Up to now, this has been totally unknown and is conceivable only in connection with the invention. The principles involved in a flocculation using oppositely charged polymers are completely different from a flocculation involving identically charged polymers or identical polymers and accordingly also necessitate different evaluation methods of measurement technology for an automation of the flocculation process.

In accordance with the invention, it is determined precisely what quantity of flocculants needs to be added in the first step in order for an improvement of the dewatering to be achieved overall. To this end, the focus is placed on the point at the start of the flocculation, which, in DE 696 04 348 T2 and the other prior art, has never played a role and which has been totally unknown up to now. If, in the first stage, too much or too little polymer, compared with the value determined in accordance with the invention, is added, then the optimal improvement in the dewaterability is also not achieved.

Even in the case of a twofold addition, what is crucial is an avoidance of a flocculation in the first stage, whereas, in the case of the two-stage flocculation using oppositely charged polymers or macromolecules, an optimal flocculation is the very aim in the first stage as well.

Because the sensors in DE 696 04 348 T2 and EP 0 754 941 B1 are not designed to detect the start of flocculation in accordance with the invention, they are also unable to optimally provide any addition of flocculant.

The advantages and special requirements placed on the dosing of the polymer in connection with a twofold addition of polymers of identical charge are likewise recognized and implemented in practice only in the corresponding embodiments of the present invention.

In the case of the twofold addition of equally charged polymers of an identical or else different kind, a determination of the degree of flocculation is not crucial, because the flocs that are formed in the first stage are already destroyed in the second stage.

For the person skilled in the art, what is important in the invention is that, in the first stage, no flocculation indeed occurs. What is therefore important is that the state at the start of the very first flocculation is detected adequately enough. The requirements in terms of measurement technology for adjustment of the optimum dosed quantity of the polymer that is to be added in the first stage can be employed neither through a degree of flocculation, nor through a solids content, nor through the detection of the floc solidity as parameters for the control of the quantity of polymer in the first stage.

The method according to the invention can be employed with success both for a conduct of the method that is continuous as viewed overall and for a batchwise conduct of the method. It is therefore possible in a batchwise operation to conduct the addition of sewage sludge in a plant in a discontinuous manner, in which a specific quantity of the sewage sludge that is to be treated or of another suspension is treated in full in a plant before a further quantity is treated in the same plant.

However, it is likewise also possible to modify a continuous conduct of the method in accordance with the invention such that sewage sludge or another suspension that is to be treated is fed continuously to the plant in order to be subjected there to the various method steps.

The different examples above are described first and foremost in regard to a dewatering of a sewage sludge. As already discussed in the introduction, however, a different solid-liquid separation is also basically possible when the suspensions that are to be treated indicate such a different form of separation for certain reasons.

Further preferred features and procedural approaches are described in the dependent claims and in the description of appended figures.

Two exemplary embodiments of the conduct of the method according to the invention will be explained below on the basis of the drawings. Shown are:

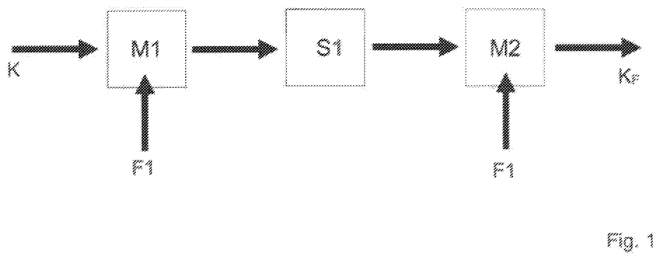

FIG. 1 a first alternative of a method according to the invention;

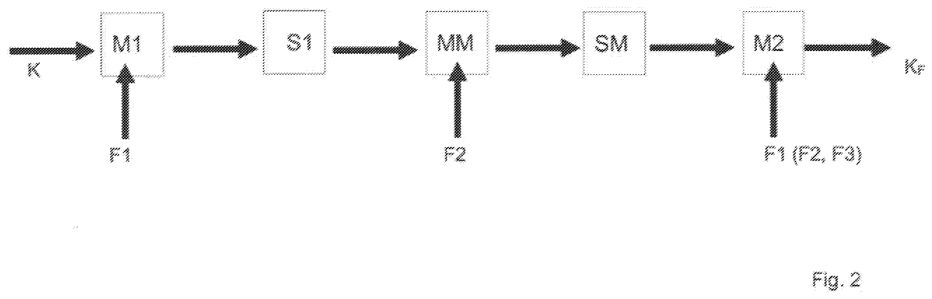

FIG. 2 a second alternative of a method according to the invention; and

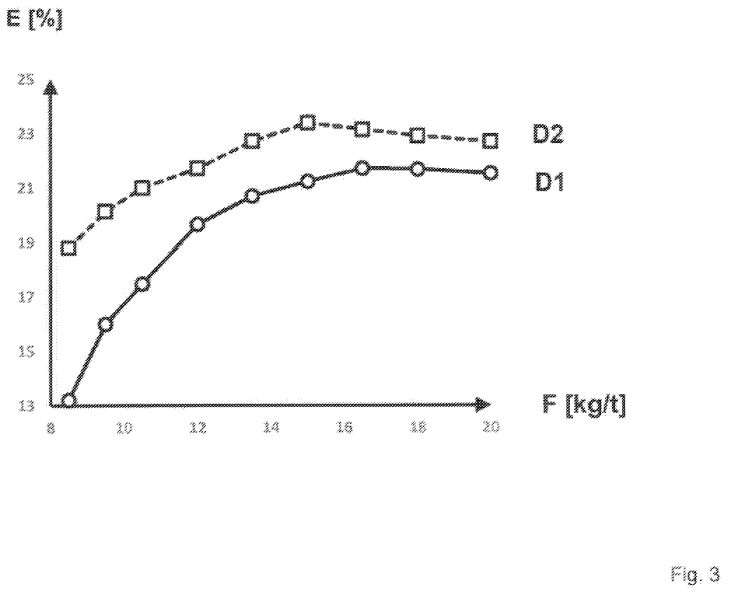

FIG. 3 a comparison of a single addition and a twofold addition of flocculants to a sewage sludge suspension (polymer input in kg/t dry residue)

In a first illustrated embodiment, the method according to the invention serves for processing sewage sludge K by means of flocculants F1 and/or F2.

In the first embodiment of the method according to the invention, illustrated in FIG. 1, sewage sludge K is fed in the form of a suspension containing a substantial amount of water to a mixer or to a mixing stage M1. A flocculant F1, such as, for example, a polymer, is fed to the mixing stage M1 at the same time.

Attached to this mixing stage M1 is a sensor S1, which preferably operates by image analysis and has a camera for this purpose. The sensor S1 observes whether, during the addition of the flocculant F1, flocs are already formed in the suspension of the sewage sludge K in the mixing stage M1 or whether this is not the case. The sensor therefore does not undertake or does not necessarily undertake closer investigations as to the kind of flocs. What is important is whether the existence of flocs can already be affirmed.

If this is the case, then the sensor S1 interrupts the further addition of flocculant F1 to the mixing stage M1 and/or reports this circumstance to a control device (not shown), which controls the dosing and quantity of the flocculant F1 fed to the next batch or the next sections of a continuously fed quantity of sewage sludge K.

In any case, after this observation of the suspension of the sewage sludge K, the new mixture resulting in the mixing stage M1 and containing no flocs or only a very small quantity of flocs is fed to a second mixing stage M2. In the case of a continuous conduct of the method, the sensor S1 can also be arranged on the conveyor line of the sewage sludge K from the mixing stage M1 to the mixing stage M2 and, from there, can make use of its observation of the flowing sewage sludge K with the just forming flocs for control of the further feeding of the flocculant F1.

Also, further flocculant F1 (or, in certain applied cases, another flocculant F2) is fed to the mixing stage M2 at the same time. The quantity of flocculant F1 or F2 that is fed to the mixing stage M2 is calculated exactly in advance in the embodiment illustrated, because the exact flocculation amounts of the fed suspension are known and, accordingly, when further flocculant F1 is added, in many cases, exactly predictable or at least sufficiently exactly predictable flocculation effects start to occur.

After the addition of this flocculant to the mixing stage M2 and the formation of the exactly intended, optimized number of flocs, the resulting suspension K_{F} obtained from the sewage sludge, the water contained in it, and the flocked particles, is fed to a further processing stage (not illustrated) for dewatering.

It has been found in tests that, by using a procedural approach of this kind, it is possible to achieve very good results. A two-stage dosing and mixing leads to very advantageous dosing possibilities for the minimum dosed quantity in the first mixing stage in comparison to a conventional one-stage dosing and mixing. The tests were carried out on the example of a dewatering of a digested sludge.

In the case of the digested sludge, values of about 3 kg of active substance per ton of dry matter have been obtained as values for the quantity of flocculant F1 that is to be fed.

In the case of conventional methods carried out in one stage, the quantity of flocculant F1 to be used was about 18 kg of active substance per 1 ton of dry matter. This is the quantity of flocculant F1 for which, in conventional methods, the highest dewatering results were obtained.

In carrying out the method in accordance with the invention using a two-stage design composed of two mixing stages and two additions of flocculants, it was possible to reduce the total quantity of flocculant to be added to 11.25 kg of active substance per 1 ton of dry matter.

The tests also have already shown that there should be neither a shortfall nor an exceeding of the minimum dosed quantity, because, in both cases, the dewatering results worsen in comparison to an exact dosing.

This confirms the advantages of the invention, for which a minimum dosed quantity to be adjusted in the first mixing stage M1 for the flocculant F1 to be added is very crucial for the functioning of the twofold or multifold mixing process.

In comparison to conventional methods, there results an overall reduction in the consumption of flocculant, that is, in the sum total of all flocculant quantities from the first mixing stage and the second mixing stage. Furthermore, there results an improvement in the thickening and dewatering result and in the solid-liquid separation properties.

A sensor with an image-analysis evaluation of photo-optically recorded images of a CCD camera has proven to be especially suitable for the sensor S1. In this way, the start of the flocculation, which is the crucial factor, can be detected especially well.

In order to determine concrete values for a control device, it is possible, for example, to choose an increase in the number of detected flocs with diameters of greater than 500 μm and/or a decrease in detected flocs with a diameter of less than 500 μm or less than 125 μm.

Shown in FIG. 2 is a second embodiment of the method according to the invention.

The start of the method proceeds here as in the first embodiment. Sewage sludge K is fed to the mixing stage M1. In the process, flocculant F1 is added to it. A sensor S1 detects whether, during the mixing operation, flocs have formed and, when the first flocs have formed, interrupts the further feeding of flocculant F1 to the mixing stage M1.

In contrast to the first embodiment, the sewage sludge K containing the added flocculant F1 and the first flocs that have formed is now fed to an intermediate mixing stage MM. Here, the addition of another different flocculant F2 now takes place. In this mixing stage MM, a dual flocculation therefore occurs. This is an addition of different flocculants to the same substance, namely, the sewage sludge K. By way of such a dual flocculation, the circumstance that oppositely charged polymers have specific attraction properties can be exploited.

In this way, additional effects that are very advantageous for the solid-liquid separation are achieved. Preferably, a specific predetermined dosed quantity is employed in this intermediate mixing stage MM with the added flocculant F2.

A further sensor SM of the intermediate mixing stage MM now establishes the impact of the addition of the flocculant F2.

This has the advantage that, in the case of fluctuating sludge and water characteristics of the sewage sludge K, a customized and thus optimal control of the dosed quantity is possible. The sensor SM can operate by an image analysis of the flocculation.

Conceivable are a control both of the addition of the flocculant F1 to the mixing stage M1 and also of the flocculant F2 to the mixing stage MM.

After the image analysis of the flocculation in the sensor SM, the sewage sludge proceeds, in turn, now with addition of the flocculants F1 and F2, to the second mixing stage M2. On account of the intermediate connection of the intermediate mixing stage MM in the sequence, this second mixing stage M2 is now the third mixing stage. However, it has the function of the second mixing stage M2 of the first exemplary embodiment, so that, here, for better differentiation, the term second mixing stage M2 is used.

Here, too, the flocculant F1 or, if need be, also the flocculant F2 or a third flocculant F2 is added to the mixing stage M2.

In this case, the resulting suspension K_{F} also leaves the second mixing stage M2.

Schematically depicted in FIG. 3 are the measurement results and laboratory tests that correspond essentially to the first alternative of the method according to the invention of the twofold dosing. As a comparison, the curve for the single dosing of flocculant is also depicted.

Plotted at the right is the quantity of flocculant F and, namely, the numerical values refer to the polymer input in kilograms of active substance in relation to the quantity of the dry matter to be treated in tons.

Plotted at the top is a prognosis for the value E of the floc formation effects. The given numbers refer to the dry matter of the floc formation effects E in percent.

As a comparison, two curves D1 and D2 are drawn here. The bottom curve D1, drawn as a solid line, refers to the conventional single dosing of a flocculant F and the upper curve D2, drawn as a dashed line, refers to the twofold dosing in accordance with the invention.

The quantity of flocculant F1 or F2 that is fed to the mixing stage M2 can be calculated exactly in advance by means of the depicted course of the curves for the twofold dosing, because the exact flocculation amounts of the supplied suspension are known and, accordingly, during the addition of further flocculent F1, there occur in many cases exactly predictable or at least sufficiently exactly predictable flocculation effects.

### LIST OF REFERENCE CHARACTERS

D1 dosing, single
D2 dosing, twofold
E effect of floc formation
F flocculant
F1 flocculant 1
F2 flocculant 2
F3 flocculant 3
K sewage sludge containing water portion
K_{F} sewage sludge containing water portion and flocked particles
M1 mixer 1
M2 mixer 2
MM intermediate mixer
S1 sensor 1
SM sensor of the intermediate mixing stage MM
WS active substance
TR dry residue

1. A method for separating solids and liquids in suspensions, in particular sewage sludge (K),
by adding flocculants (F1) and/or flocculating agents, in which, the suspension, in particular the sewage sludge (K), is observed by means of a sensor (S1),
is hereby characterized
in that, in a first method step, flocculants (F1) and/or flocculating agents are added to a first mixing stage (M1) until the sensor (S1) detects the formation of first flocs;
in that the addition of the flocculant (F1) and/or the flocculating agent is then interrupted, so that the suspension, in particular the sewage sludge (K), has a defined, specifically a first floc-comprising state at that moment;
in that the suspension, in particular the sewage sludge (K), is now fed to a further mixing stage (M2, MM);
in that, in this further mixing stage (M2, MM), the same flocculant (F1) or a different flocculant (F2) or flocculating agent is added in a quantity which is predefined and which, starting from the defined state of the suspension, in particular the sewage sludge (K), causes a desired proportion of flocs in the suspension, in particular the sewage sludge (K); and
in that the resulting mixture is then fed directly or indirectly to a solid-liquid separation system.

2. The method according to claim 1,
further characterized
in that, as a second flocculant (F2), a macromolecule or polymer that is identical in charge to the first flocculant (F1) is used.

3. The method according to claim 1,
further characterized
in that the sensor (S1) has a camera and/or carries out an image analysis measurement of the suspension, in particular the sewage sludge (K).

4. The method according to claim 1,
further characterized
in that the quantity of the flocculant (F1 or F2) and/or flocculating agent fed to the further mixing stage (M2) is constant and is determined in advance.

5. The method according to claim 1,
further characterized
in that the quantity of flocculants (F1 or F2) and/or flocculating agents fed to the further mixing stage (M2, MM) is determined;
in that the floc structure in the suspension, in particular the sewage sludge (K), is detected transversely with respect to the flow direction by one-dimensional photo-optical incident light measurement of image rows of the grayscale profiles of a view from the top onto the suspension, in particular the sewage sludge (K),
in that chord lengths of the detected floc structure are determined from the grayscale profiles, with the chord length being the distance between a relative grayscale maximum value and an adjacent relative grayscale minimum value, with the frequency for the distribution of the chord lengths being calculated and a concentration factor being determined as a function of parameters that are determined from the chord lengths with the frequency distribution of the chord lengths.

6. The method according to claim 1,
further characterized
in that a third mixing stage (MM) is provided, which, after the addition of the same or a different flocculant (F1 or F2) and/or flocculating agent to the suspension, in particular the sewage sludge (K), forming in the intermediate mixing stage (MM), is observed using a further sensor (SM), in particular a concept operating by image analysis, in particular with a camera, in order to control the addition of the flocculant.

7. An arrangement for separating solids and liquids in suspensions, in particular sewage sludge (K), by adding flocculants (F1) and/or flocculating agents, in which, the suspension, in particular the sewage sludge (K), is observed by means of a sensor (S1),
is hereby characterized
in that a first mixing stage (M1) is provided, in which, in a first method step, flocculants (F1) and/or flocculating agents are added until the sensor (S1) detects the formation of first flocs;
in that the addition of the flocculant (F1) and/or the flocculating agent is then interrupted, so that the suspension, in particular the sewage sludge (K), has a defined state, namely first floc-comprising state at this moment;
in that a further mixing stage (M2, MM) is provided, to which the suspension, in particular the sewage sludge (K), is fed,
in that, in this further mixing stage (M2, MM), the same flocculant (F1) or a different flocculant (F2) or flocculating agent is added in a quantity that is predefined and, starting from the defined state of the suspension, in particular the sewage sludge (K), brings about a desired proportion of flocs in the suspension, in particular the sewage sludge (K); and
in that the resulting mixture is then fed directly or indirectly to a solid-liquid separation system.

8. The arrangement according to claim 7,
further characterized
in that, as a second flocculant (F2), a macromolecule or polymer that is identical in charge to the first flocculant (F1) is used.

9. The arrangement according to claim 7,
further characterized
in that the sensor (S1) has a camera and/or carries out an image analysis measurement of the suspension, in particular the sewage sludge (K).

10. The arrangement according to claim 7,
further characterized
in that the quantity of the flocculant (F1 or F2) and/or flocculating agent fed to the further mixing stage (M2) is constant and is determined in advance.

11. The arrangement according to claim 7,
further characterized
in that the quantity of flocculants (F1 or F2) and/or flocculating agents fed to the further mixing stage (M2, MM) is determined;
in that the floc structure in the suspension, in particular the sewage sludge (K), is detected transversely with respect to the flow direction by one-dimensional photo-optical incident light measurement of image rows of the grayscale profiles of a view from the top onto the suspension, in particular the sewage sludge (K);
in that chord lengths of the detected floc structure are determined from the grayscale profiles, with the chord length being the distance between a relative grayscale maximum value and an adjacent relative grayscale minimum value, with the frequency for the distribution of the chord lengths being calculated and a concentration factor being determined as a function of parameters that are determined from the chord lengths with the frequency distribution of the chord lengths.

12. The arrangement according to claim 7,
further characterized
in that a third mixing stage (MM) is provided, which, after the addition of the same or a different flocculant (F1 or F2) and/or flocculating agent to the suspension, in particular the sewage sludge (K), forming in the intermediate mixing stage (MM), is observed using a further sensor (SM), in particular a concept operating by image analysis, in particular with a camera, in order to control the addition of the flocculant.

13. The method according to claim 1
further characterized
in that, as a second flocculant (F2), a macromolecule or polymer that is identical in charge to the first flocculant (F1) is used; and
in that the sensor (S1) has a camera and/or carries out an image analysis measurement of the suspension, in particular the sewage sludge (K).

14. The method according to claim 1,
further characterized
in that the sensor (S1) has a camera and/or carries out an image analysis measurement of the suspension, in particular the sewage sludge (K); and
in that the quantity of the flocculant (F1 or F2) and/or flocculating agent fed to the further mixing stage (M2) is constant and is determined in advance.

15. The method of claim 1,
further characterized
in that the quantity of the flocculant (F1 or F2) and/or flocculating agent fed to the further mixing stage (M2) is constant and is determined in advance;
in that the quantity of flocculants (F1 or F2) and/or flocculating agents fed to the further mixing stage (M2, MM) is determined;
in that the floc structure in the suspension, in particular the sewage sludge (K), is detected transversely with respect to the flow direction by one-dimensional photo-optical incident light measurement of image rows of the grayscale profiles of a view from the top onto the suspension, in particular the sewage sludge (K),
in that chord lengths of the detected floc structure are determined from the grayscale profiles, with the chord length being the distance between a relative grayscale maximum value and an adjacent relative grayscale minimum value, with the frequency for the distribution of the chord lengths being calculated and a concentration factor being determined as a function of parameters that are determined from the chord lengths with the frequency distribution of the chord lengths.

16. The method according to claim 1,
further characterized
in that, as a second flocculant (F2), a macromolecule or polymer that is identical in charge to the first flocculant (F1) is used;
further characterized
in that the sensor (S1) has a camera and/or carries out an image analysis measurement of the suspension, in particular the sewage sludge (K);
further characterized
in that the quantity of the flocculant (F1 or F2) and/or flocculating agent fed to the further mixing stage (M2) is constant and is determined in advance;
further characterized
in that the quantity of flocculants (F1 or F2) and/or flocculating agents fed to the further mixing stage (M2, MM) is determined;
in that the floc structure in the suspension, in particular the sewage sludge (K), is detected transversely with respect to the flow direction by one-dimensional photo-optical incident light measurement of image rows of the grayscale profiles of a view from the top onto the suspension, in particular the sewage sludge (K),
in that chord lengths of the detected floc structure are determined from the grayscale profiles, with the chord length being the distance between a relative grayscale maximum value and an adjacent relative grayscale minimum value, with the frequency for the distribution of the chord lengths being calculated and a concentration factor being determined as a function of parameters that are determined from the chord lengths with the frequency distribution of the chord lengths;
further characterized
in that a third mixing stage (MM) is provided, which, after the addition of the same or a different flocculant (F1 or F2) and/or flocculating agent to the suspension, in particular the sewage sludge (K), forming in the intermediate mixing stage (MM), is observed using a further sensor (SM), in particular a concept operating by image analysis, in particular with a camera, in order to control the addition of the flocculant.

17. The arrangement according to claim 7,
further characterized
in that, as a second flocculant (F2), a macromolecule or polymer that is identical in charge to the first flocculant (F1) is used;
further characterized
in that the sensor (S1) has a camera and/or carries out an image analysis measurement of the suspension, in particular the sewage sludge (K).

18. The arrangement according to claim 7,
further characterized
in that the sensor (S1) has a camera and/or carries out an image analysis measurement of the suspension, in particular the sewage sludge (K);
further characterized
in that the quantity of the flocculant (F1 or F2) and/or flocculating agent fed to the further mixing stage (M2) is constant and is determined in advance.

19. The arrangement according to claim 7,
further characterized
in that, as a second flocculant (F2), a macromolecule or polymer that is identical in charge to the first flocculant (F1) is used;
further characterized
in that the sensor (S1) has a camera and/or carries out an image analysis measurement of the suspension, in particular the sewage sludge (K);
further characterized
in that the quantity of flocculants (F1 or F2) and/or flocculating agents fed to the further mixing stage (M2, MM) is determined;
in that the floc structure in the suspension, in particular the sewage sludge (K), is detected transversely with respect to the flow direction by one-dimensional photo-optical incident light measurement of image rows of the grayscale profiles of a view from the top onto the suspension, in particular the sewage sludge (K);
in that chord lengths of the detected floc structure are determined from the grayscale profiles, with the chord length being the distance between a relative grayscale maximum value and an adjacent relative grayscale minimum value, with the frequency for the distribution of the chord lengths being calculated and a concentration factor being determined as a function of parameters that are determined from the chord lengths with the frequency distribution of the chord lengths.

20. The arrangement according to claim 7,
further characterized
in that, as a second flocculant (F2), a macromolecule or polymer that is identical in charge to the first flocculant (F1) is used;
further characterized
in that the sensor (S1) has a camera and/or carries out an image analysis measurement of the suspension, in particular the sewage sludge (K);
further characterized
in that a third mixing stage (MM) is provided, which, after the addition of the same or a different flocculant (F1 or F2) and/or flocculating agent to the suspension, in particular the sewage sludge (K), forming in the intermediate mixing stage (MM), is observed using a further sensor (SM), in particular a concept operating by image analysis, in particular with a camera, in order to control the addition of the flocculant.
